(19) United States
(12) Patent Application Publication
(10) Pub. No.: US 2011/0027685 A1
(43) Pub. Date: Feb. 3, 2011

(54) FUEL CELL COMPRISING MULTI-TUBULAR SUPPORT

(76) Inventors: Eon Soon LEE, Gyeongsangbuk-do (KR); Jae Hyuk Jang, Gyunggi-do (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/562,906

(22) Filed: Sep. 18, 2009

(30) Foreign Application Priority Data
Jul. 29, 2009 (KR) 10-2009-0069591

(51) Int. Cl. H01M 8/10; H01M 8/00

(52) U.S. Cl. 429/483; 429/508

(57) ABSTRACT

Disclosed herein is a fuel cell including a multi-tubular support, including: a multi-tubular support consisting of a plurality of tubular supports which are concentrically arranged and have different diameters; a connection support extending from the innermost tubular support to the outermost tubular support of the plurality of tubular supports; and a membrane electrode assembly formed on the multi-tubular support or the connection support. The fuel cell is advantageous in that, since it includes the multi-tubular support, a reaction area is enlarged, so that the efficiency of a fuel cell is increased, thereby to decreasing power generation costs.

### CROSS REFERENCE TO RELATED APPLICATION

This application claims the benefit of Korean Patent Application No. 10-2009-0069591, filed Jul. 29, 2009, entitled “Fuel cell having multi-tubular support”, which is hereby incorporated by reference in its entirety into this application.

### BACKGROUND OF THE INVENTION

1. Technical Field

The present invention relates to a fuel cell comprising a multi-tubular support.

2. Description of the Related Art

A fuel cell is an apparatus for directly converting the chemical energy of a fuel (hydrogen, LNG, LPG or the like) and air into electric energy and thermal energy through an electrochemical reaction. Differently from conventional electric power systems operated by the procedures of burning fuel, generating steam, driving a turbine and driving an electric generator, a fuel cell has high efficiency and does not cause environmental problems because it does not require a fuel burning procedure nor a driving device.

FIG. 1 is a view explaining the operating principle of a fuel cell.

Referring to FIG. 1, an anode serves to decompose hydrogen (H₂) into hydrogen ions (H⁺) and electrons (e⁻). Hydrogen ions are transferred to a cathode 3 through an electrolyte 2. Electrons are converted into an electric current through an external circuit 4. In the cathode 3, hydrogen ions and electrons react with the oxygen (O₂) in air to produce water (H₂O). This chemical reaction in a fuel cell 10 is represented by Reaction Formula 1 below.

Anode: H₂→2H⁺+2e⁻

Cathode: ½O₂+2H⁺+2e⁻→H₂O

Total: H₂+½O₂→H₂O [Reaction Formula 1]

That is, the electrons produced from the decomposition of hydrogen at the anode 1 are converted into an electric current through an external circuit 4, thus realizing the purpose and function of a fuel cell. Such a fuel cell 10 is advantageous in that air pollutants, such as SOₓ, NOₓ and the like, are discharged in small amounts, a very small amount of carbon dioxide is generated, and noise and vibration do not occur.

Meanwhile, there are various kinds of fuel cells, such as a phosphoric acid fuel cell (PAFC), an alkaline fuel cell (AFC), a polymer electrolyte membrane fuel cell (PEMFC), a direct methanol fuel cell (DMFC), a solid oxide fuel cell (SOFC) and the like. Among them, the solid oxide fuel cell (SOFC) is advantageous in that high-efficiency power generation is possible, complex power generation using coal gases, fuel cells and gas turbines is possible, and it is suitable for use in small-sized power plants, large-sized power plants or distributed power sources because it has different power generation capacities. Therefore, the solid oxide fuel cell (SOFC) is a power generating technology that is necessary for going into the hydrogen economy of the future.

However, several problems must be solved in order to put the solid oxide fuel cell (SOFC) to practical use.

First, the problems of low durability and reliability must be solved. Since the solid oxide fuel cell (SOFC) operates at high temperature, its performance is deteriorated by a thermal cycle. In particular, the solid oxide fuel cell (SOFC) is problematic in that its durability and reliability is rapidly lowered depending on the increase in size thereof because of properties of the ceramic.

Further, the solid oxide fuel cell (SOFC) is problematic in that its power generation cost is higher than that of a conventional power generator such as a gas turbine or a diesel generator although it uses relatively cheap ceramic materials. Therefore, efforts to decrease the power generation cost of the solid oxide fuel cell have been actively made, but solid oxide fuel cells having price competitiveness superior to that of conventional power generators have not yet been developed.

### SUMMARY OF THE INVENTION

Accordingly, the present invention has been made to solve the above-mentioned problems, and the present invention provides a fuel cell including a multi-tubular support, which can improve durability and reliability and which can increase power generation efficiency by enlarging a reaction area.

An aspect of the present invention provides a fuel cell including a multi-tubular support, including: a multi-tubular support composed of a plurality of tubular supports which are concentrically arranged and have different diameters; at least one connection support extending from the innermost tubular support to the outermost tubular support of the plurality of tubular supports; and a membrane electrode assembly formed on the multi-tubular support or the connection support.

Here, the multi-tubular support includes an inner tubular support and an outer tubular support; the connection support extends from the inner tubular support to the outer tubular support; and the membrane electrode assembly includes an inner membrane electrode assembly formed on an inner side of the inner tubular support and an outer membrane electrode assembly formed on an outer side of the outer tubular support. The inner membrane electrode assembly includes an anode, an electrolyte membrane and a cathode sequentially layered in this order on the inner side of the inner tubular support, and the outer membrane electrode assembly includes an anode, an electrolyte membrane and a cathode sequentially layered in this order on the outer side of the outer tubular support.

The inner membrane electrode assembly includes a cathode, an electrolyte membrane and an anode sequentially layered in this order on the inner side of the inner tubular support, and the outer membrane electrode assembly includes a cathode, an electrolyte membrane and an anode sequentially layered in this order on the outer side of the outer tubular support.

Further, the multi-tubular support includes an inner tubular support and an outer tubular support; the connection support extends from the inner tubular support to the outer tubular support; and the membrane electrode assembly is formed between an outer side of the inner tubular support, an inner side of the outer tubular support and both sides of the connection support.

The membrane electrode assembly includes an anode, an electrolyte membrane and a cathode sequentially layered in this order on the outer side of the inner tubular support, the inner side of the outer tubular support and both sides of the connection support.

The membrane electrode assembly includes a cathode, an electrolyte membrane and an anode sequentially layered in this order on the outer side of the inner tubular support, the inner side of the outer tubular support and both sides of the connection support.

Further, the multi-tubular support includes an inner tubular support, an intermediate tubular support and an outer tubular support; the connection support includes a first connection support extending from the inner tubular support to the intermediate tubular support and a second connection part extending from the intermediate tubular support to the outer tubular support; and the membrane electrode assembly includes an inner membrane electrode assembly formed between an outer side of the inner tubular support, an inner side of the intermediate tubular support and both sides of the first connection support and an outer membrane electrode assembly formed on an outer side of the outer tubular support.

The inner membrane electrode assembly includes an anode, an electrolyte membrane and a cathode sequentially layered in this order on the outer side of the inner tubular support, the inner side of the intermediate tubular support and both sides of the first connection support, and the outer membrane electrode assembly includes an anode, an to electrolyte membrane and a cathode sequentially layered in this order on the outer side of the outer tubular support.

The inner membrane electrode assembly includes a cathode, an electrolyte membrane and an anode sequentially layered in this order on the outer side of the inner tubular support, the inner side of the intermediate tubular support and both sides of the first connection support, and the outer membrane electrode assembly includes a cathode, an electrolyte membrane and an anode sequentially layered in this order on the outer side of the outer tubular support.

Further, the multi-tubular support includes an inner tubular support, an intermediate tubular support and an outer tubular support; the connection support includes a first connection support extending from the inner tubular support to the intermediate tubular support and a second connection part extending from the intermediate tubular support to the outer tubular support; and the membrane electrode assembly includes an inner membrane electrode assembly formed on an inner side of the inner tubular support and an outer membrane electrode assembly formed between an inner side of the outer tubular support, an outer side of the intermediate tubular support and both sides of the second connection support.

The inner membrane electrode assembly includes an anode, an electrolyte membrane and a cathode are sequentially layered in this order on the inner side of the inner tubular support, and the outer membrane electrode assembly includes an anode, an electrolyte membrane and a cathode sequentially layered in this order on the outer side of the intermediate tubular support, the inner side of the outer tubular support and both sides of the second connection support.

The inner membrane electrode assembly includes a cathode, an electrolyte membrane and an anode sequentially layered in this order on the inner side of the inner tubular support, and the outer membrane electrode assembly includes a cathode, an to electrolyte membrane and an anode sequentially layered in this order on the outer side of the intermediate tubular support, the inner side of the outer tubular support and both sides of the second connection support.

The multi-tubular support may be integrated with the connection support.

The number of the connection support is two or more.

The multi-tubular support or the connection support may be made of ceramic.

The multi-tubular support or the connection support may be made of a metal.

The metal may be selected from the group consisting of iron, copper, aluminum, nickel, chromium, alloys thereof, and combinations thereof.

The multi-tubular support or the connection support may be made of a porous material.

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view explaining the operating principle of a fuel cell;

FIGS. 2A to 2C are sectional views showing fuel cells including a multi-tubular support according to an embodiment of the present invention;

FIGS. 3 and 4 are sectional views showing fuel cells including a multi-tubular support according to a first embodiment of the present invention;

FIGS. 5 and 6 are sectional views showing fuel cells including a multi-tubular support according to a second embodiment of the present invention;

FIGS. 7 and 8 are sectional views showing fuel cells including a multi-tubular support according to a third embodiment of the present invention; and

FIGS. 9 and 10 are sectional views showing fuel cells including a multi-tubular support according to a fourth embodiment of the present invention.

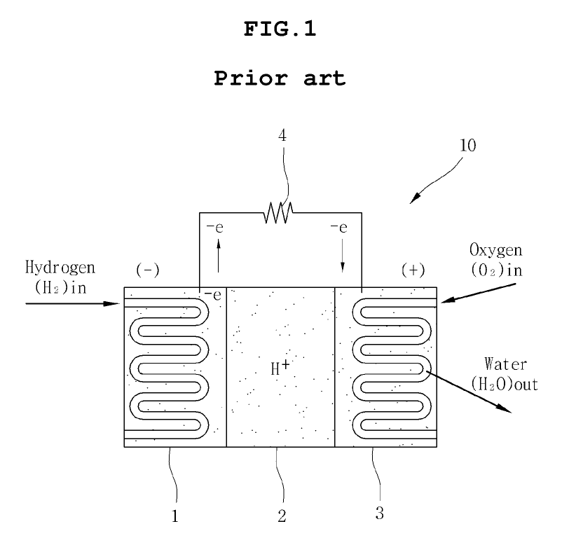

### DESCRIPTION OF THE PREFERRED EMBODIMENTS

The objects, features and advantages of the present invention will be more clearly understood from the following detailed description and preferred embodiments taken in conjunction with the accompanying drawings. Throughout the accompanying drawings, the same reference numerals are used to designate the same or similar components, and redundant descriptions thereof are omitted. Further, O₂ and H₂ shown in the drawings is set forth to concretely explain the operation of a fuel cell, but the kind of gas supplied to the anode or cathode is not limited thereto. Furthermore, in the description of the present invention, when it is determined that the detailed description of the related art would obscure the gist of the present invention, the description thereof will be omitted.

Hereinafter, preferred embodiments of the present invention will be described in detail with reference to the attached drawings.

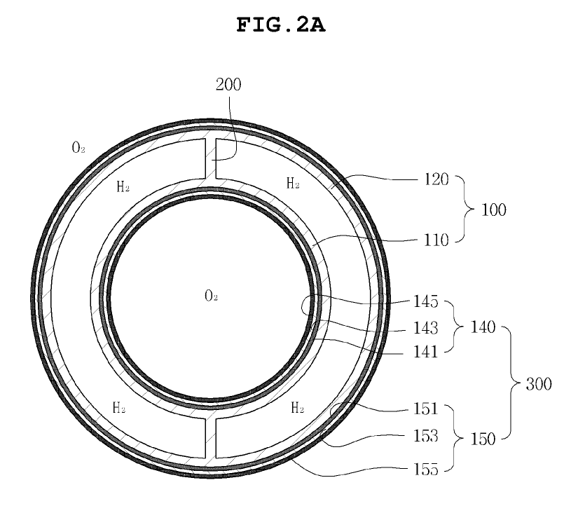

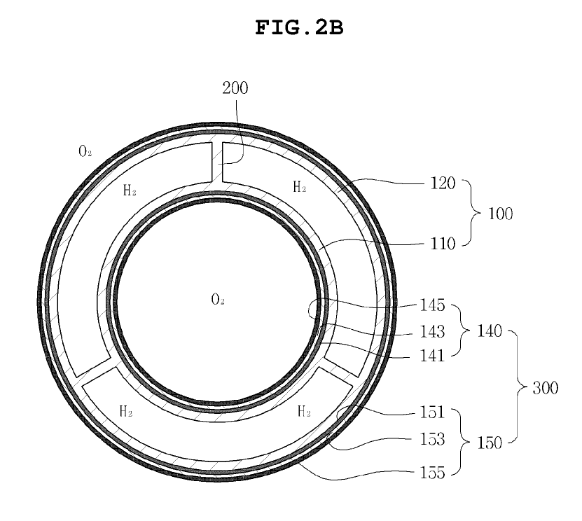

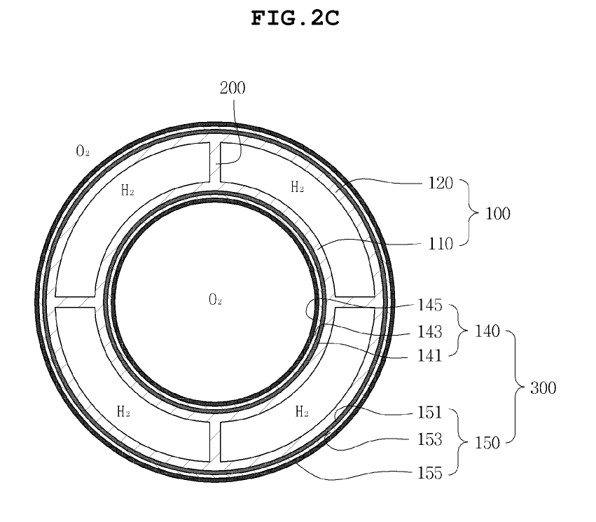

FIGS. 2A to 2C are sectional views showing fuel cells including a multi-tubular support according to an embodiment of the present invention. Hereinafter, a fuel cell including a multi-tubular support according to the present invention will be described with to reference to FIGS. 2A to 2C.

As shown in FIGS. 2A to 2C, the fuel cell including a multi-tubular support according to the present invention includes: a multi-tubular support 100 consisting of a plurality of tubular supports which are concentrically arranged and have different diameters; a connection support 200 extending from the innermost tubular support to the outermost tubular support of the plurality of tubular supports; and a membrane electrode assembly 300 formed on the multi-tubular support 100 or the connection support 200.

The multi-tubular support 100 serves to support the membrane electrode assembly 300. Since the multi-tubular support 100 consists of a plurality of tubular supports, the area of the multi-tubular support 100 coated with the membrane electrode assembly 300 is larger than that of a conventional support when the volume of the multi-tubular support 100 is equal to that of the membrane electrode assembly, thus increasing the efficiency of a fuel cell.

Further, the plurality of tubular supports of the multi-tubular support 100 is concentrically formed, and is interconnected through the connection support 200. Although the fuel cell of the present invention may be manufactured by preparing a multi-tubular support 100, in which a plurality of tubular supports having different diameters are concentrically arranged, and then connecting the multi-tubular support 100 with the connection support 200, the fuel cell of the present invention may also be manufactured by integrating the multi-tubular support 100 with the connection support 200 through extruding, injection molding, gel casting, slip casting, pressing or the like. When the multi-tubular support 100 is integrated with the connection support 200, the production costs thereof can be reduced, and the mechanical strength thereof can be increased. Further, when the multi-tubular support 100 is integrated with the connection support 200, it is preferred that the material of the multi-tubular support 100 be identical to that of the connection support 200.

Here, it is preferred that the plurality of tubular supports be concentrically arranged. However, in the present invention, the term “concentric” as used herein does not necessarily mean that the plurality of tubular supports is disposed in the geometrically accurate alignment, and it may have allowable errors in molding.

Meanwhile, since the connection support 200 not only serves to connect the plurality of tubular supports but also serves to absorb the mechanical impact applied to a fuel cell, the multi-tubular support 100 of the present invention can be thinly formed compared to a conventional tubular support. Therefore, fuel or air can be more rapidly transferred to electrodes through the multi-tubular support 100, thus increasing the efficiency of a fuel cell. Further, the membrane electrode assembly 300 can be applied on the connection support 200, thus further increasing the reaction area of a fuel cell.

Referring to FIGS. 2A to 2C, there are two (FIG. 2A), three (FIG. 2B) or four (FIG. 2C) connection supports 200, but the number thereof is not limited thereto. That is, the number of the connection supports 200 may be two or more in order to stably connect the plurality of tubular supports. As the number of connection supports increases, the plurality of tubular supports is more stably connected. However, when the number of connection supports excessively increases, the cross-sectional area of the space in which fluid (air or gas) flows becomes narrow, and thus the performance of a fuel cell can be deteriorated. Therefore, it is preferred that a suitable number of connection supports 200 be used depending on the use of a fuel cell.

Meanwhile, the multi-tubular support 100 or the connection support 200 may be made of ceramic or metal. Further, as described above, since it is advantageous that the multi-tubular support 100 be integrated with the connection support 200, it is preferred that the multi-tubular support 100 and the connection support 200 be made of the same material. However, if necessary, they may be made of different materials in consideration of the use of a fuel cell, the forming process thereof, the production cost thereof and the like.

When the multi-tubular support 100 or the connection support 200 is made of metal, the metal may be selected from the group consisting of iron, copper, aluminum, nickel, chromium, alloys thereof, and combinations thereof. Since these components are electrically conductive, there is an advantage of the multi-tubular support 100 or the connection support 200 being able to be independently used as a collector.

Further, the multi-tubular support 100 or the connection support 200 may be made of a porous material having a gas transmission property such that it can transfer the fuel or air supplied from a manifold to the electrodes. For example, as the porous material, porous ceramic or porous metal having a shape such as a metal foam, metal plate or metal fiber may be used.

The membrane electrode assembly 300 formed on the multi-tubular support 100 or the connection support 200 includes an anode 141 or 151, an electrolyte membrane 143 or 153 and a cathode 145 or 155, and serves to generate electric energy using supplied fuel and air. Hereinafter, methods of an anode 141 or 151, an electrolyte membrane 143 or 153 and a cathode 145 or 155 are illustratively described, respectively.

The cathode 145 or 155 may be formed by coating LSM (Strontium doped Lanthanum manganite), LSCF((La,Sr)(Co,Fe)O₃) or the like using slip coating or plasma spray coating and then sintering it at a temperature of 1200˜1300° C.

The electrolyte membrane 143 or 153 may be formed by coating YSZ (Yttria stabilized Zirconia) ScSZ (Scandium stabilized Zirconia), GDC, LDC or the like using slip coating or plasma spray coating and then sintering it at a temperature of 1300˜1500° C.

The anode 141 or 151 may be formed by coating NiO—YSZ (Yttria stabilized Zirconia) using slip coating or plasma spray coating and then sintering it at a temperature of 1200˜1300° C.

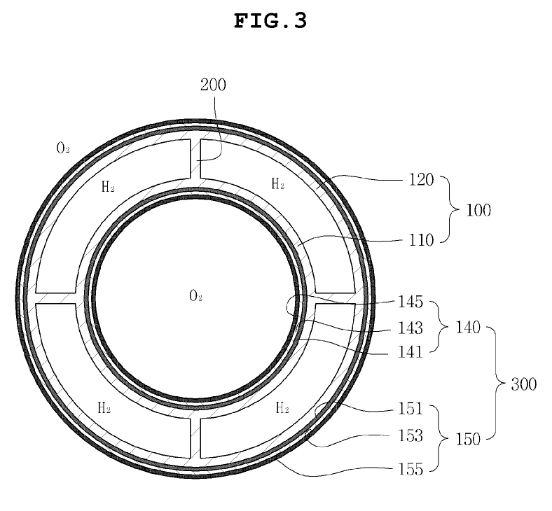

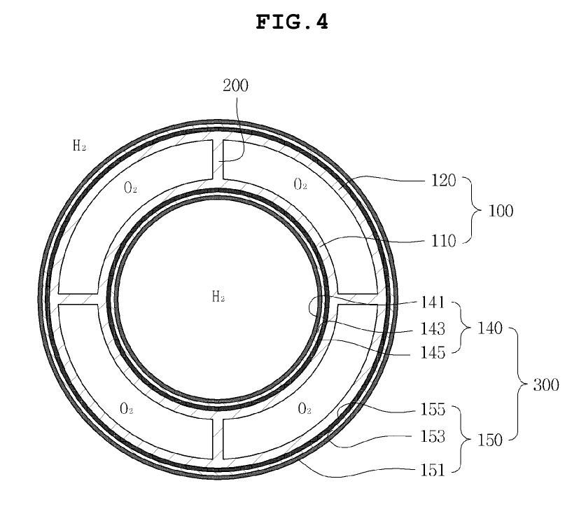

FIGS. 3 and 4 are sectional views showing fuel cells including a multi-tubular support according to a first embodiment of the present invention. As shown in FIGS. 3 and 4, each of the fuel cells including a multi-tubular support according to a first embodiment of the present invention includes: a multi-tubular support 100 including an inner tubular support 110 and an outer tubular support 120; a connection support 200 extending from the inner tubular support 110 to the outer tubular support 120; and a membrane electrode assembly 300 including an inner membrane electrode assembly 140 formed on the inner side of the inner tubular support 110 and an outer membrane electrode assembly 150 formed on the outer side of the outer tubular support 120.

That is, the multi-tubular support 100 of this embodiment is a double-tubular support including the inner tubular support 110 and the outer tubular support 120. Here, it must be cautious in that, when the membrane electrode assembly 300 is formed on all sides of the multi-tubular support 100 and the connection support 200, fuel or oxygen cannot be suitably supplied to the anodes and the cathodes, and the diffusion of fuel or oxygen is inhibited by the membrane electrode assembly 300, thus decreasing the efficiency of a fuel cell. Therefore, the membrane electrode assembly 300 must be suitably disposed in consideration of the supply of fuel and oxygen. Further, in order to prevent a short circuit, the electrodes brought into contact with the multi-tubular support 100 and the connection support 200 must be identical electrodes.

In this embodiment, the membrane electrode assembly 300 is formed only on the inner side of the inner tubular support 110 and on the outer side of the outer tubular support 120. Here, the membrane electrode assembly 300 formed on the inner side of the inner tubular support 110 is referred to as an inner membrane electrode assembly 140, and the membrane electrode assembly 300 formed on the outer side of the outer tubular support 120 is referred to as an outer membrane electrode assembly 150. Further, in this embodiment, two types of membrane electrode assemblies can be formed by changing the arrangement of the anodes and the cathodes.

First, as shown in FIG. 3, in the inner membrane electrode assembly 140, an anode 141, an electrolyte membrane 143 and a cathode 145 are sequentially layered from the inner side of the inner tubular support 110, and, in the outer membrane electrode assembly 150, an anode 151, an electrolyte membrane 153 and a cathode 155 are sequentially layered from the outer side of the outer tubular support 120. In this case, since the electrodes brought into contact with the inner tubular support 110 and the outer tubular support 120 are anodes 141 and 151, a short circuit does not occur. Further, since the outermost layer (hereinafter, the outermost layer is defined not based on the center of the multi-tubular support 100 but based on the order of layering the membrane electrode assembly 300) of the inner membrane electrode assembly 140 is the cathode 145, oxygen is supplied to the inside of the inner tubular support 110. Similarly, since the outermost layer of the outer membrane electrode assembly 150 is the cathode 155 too, oxygen is supplied to the outside of the outer tubular support 120. In contrast, fuel is supplied to the space between the inner tubular support 110 and the outer tubular support 120, and is then transferred to the anodes 141 and 151 through the inner tubular support 110 and the outer tubular support 120.

Second, as shown in FIG. 4, in the inner membrane electrode assembly 140, a cathode 145, an electrolyte membrane 143 and an anode 141 are sequentially layered from the inner side of the inner tubular support 110, and, in the outer membrane electrode assembly 150, a cathode 155, an electrolyte membrane 153 and an anode 151 are sequentially layered from the outer side of the outer tubular support 120. In this case, since the outermost layer of the inner membrane electrode assembly 140 is the anode 141, oxygen is supplied to the inside of the inner tubular support 110. Similarly, since the outermost layer of the outer membrane electrode assembly 150 is the anode 151 too, oxygen is supplied to the outside of the outer tubular support 120. In contrast, oxygen is supplied to the space between the inner tubular support 110 and the outer tubular support 120, and is then transferred to the cathodes 145 and 155 through the inner tubular support 110 and the outer tubular support 120.

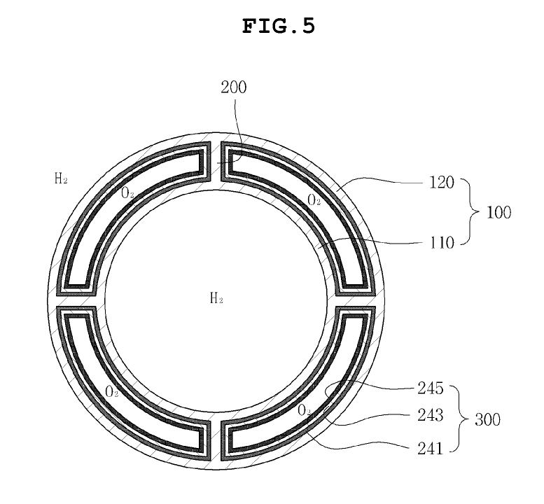

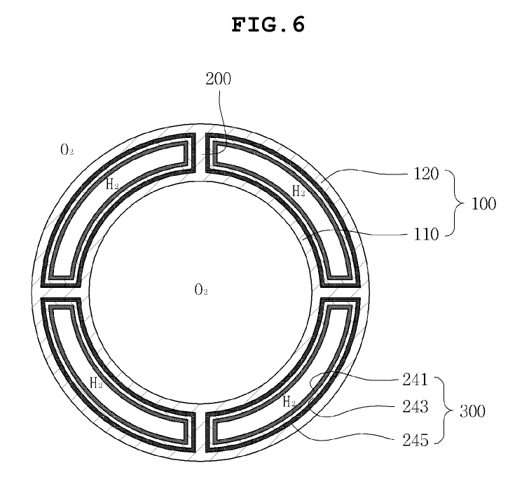

FIGS. 5 and 6 are sectional views showing fuel cells including a multi-tubular support according to a second embodiment of the present invention. As shown in FIGS. 5 and 6, each of the fuel cells including a multi-tubular support according to a second embodiment of the present invention includes: a multi-tubular support 100 including an inner tubular support 110 and an outer tubular support 120; a connection support 200 extending from the inner tubular support 110 to the outer tubular support 120; and a membrane electrode assembly 300 formed between the outer side of the inner tubular support 110, the inner side of the outer tubular support 120 and both sides of the connection support 200. Even in this embodiment, as described above, in order to suitably supply fuel or oxygen and to prevent a short circuit, the membrane electrode assembly 300 must be selectively formed only between the outer side of the inner tubular support 110, the inner side of the outer tubular support 120 and both sides of the connection support 200, and the electrodes brought into contact with the inner tubular support 110, the outer tubular support 120 and the connection support 200 must be identical electrodes. Further, as in the first embodiment, in this embodiment, two types of membrane electrode assemblies can be formed by changing the arrangement of the anodes and the cathodes.

First, as shown in FIG. 5, in the membrane electrode assembly 300, an anode 241, an electrolyte membrane 243 and a cathode 245 are sequentially layered from the outer side of the inner tubular support 110, the inner side of the outer tubular support 120 and both sides of the connection support 200. In this case, since the electrode brought into contact with the inner tubular support 110, the outer tubular support 120 and the connection support 200 is the anode 241, a short circuit does not occur. Further, since the outermost layer of the membrane electrode assembly 300 is the cathode 245, oxygen is supplied to the space between the inner tubular support 110 and the outer tubular support 120. In contrast, fuel is supplied to the inside of the inner tubular support 110 and the outside of the outer tubular support 120, and is then transferred to the anode 241 through the inner tubular support 110, the outer tubular support 120 and the connection support 200.

Second, as shown in FIG. 6, in the membrane electrode assembly 300, a cathode 245, an electrolyte membrane 243 and an anode 241 are sequentially layered from the outer side of the inner tubular support 110, the inner side of the outer tubular support 120 and both sides of the connection support 200. In this case, since the electrode brought into contact with the inner tubular support 110, the outer tubular support 120 and the connection support 200 is the cathode 245, a short circuit does not occur. Further, since the outermost layer of the membrane electrode assembly 300 is the anode 241, fuel is supplied to the space between the inner tubular support 110 and the outer tubular support 120. In contrast, oxygen is supplied to the inside of the inner tubular support 110 and the outside of the outer tubular support 120, and is then transferred to the cathode 245 through the inner tubular support 110, the outer tubular support 120 and the connection support 200.

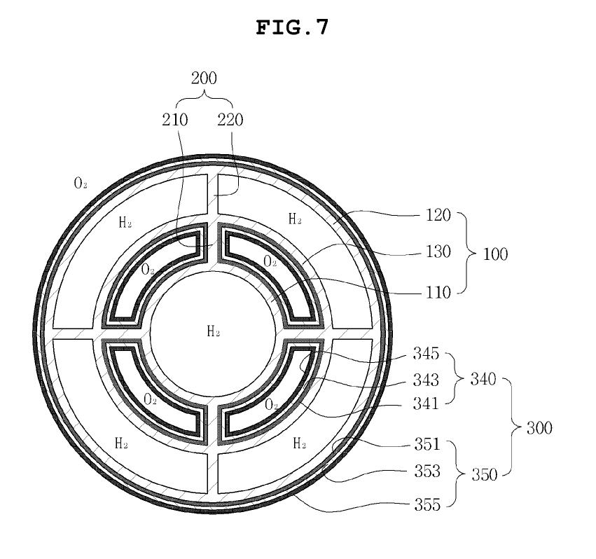

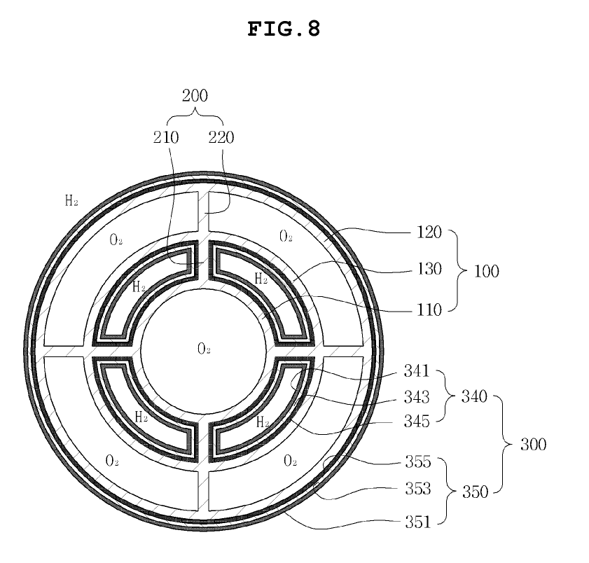

FIGS. 7 and 8 are sectional views showing fuel cells including a multi-tubular support according to a third embodiment of the present invention. As shown in FIGS. 7 and 8, each of the fuel cells including a multi-tubular support according to a third embodiment of the present invention includes: a multi-tubular support 100 including an inner tubular support 110, an intermediate tubular support 130 and an outer tubular support 120; a connection support 200 including a first connection support 210 extending from the inner tubular support 110 to the intermediate tubular support 130 and a second connection part 220 extending from the intermediate tubular support 130 to the outer tubular support 120; and a membrane electrode assembly 300 including an inner membrane electrode to assembly 340 formed between the outer side of the inner tubular support 110, the inner side of the intermediate tubular support 130 and both sides of the first connection support 210 and an outer membrane electrode assembly 350 formed on the outer side of the outer tubular support 120.

That is, the multi-tubular support 100 of this embodiment is a triple-tubular support including the inner tubular support 110, the intermediate tubular support 130 and the outer tubular support 120. Even in this embodiment, as described above, in order to suitably supply fuel or oxygen and to prevent a short circuit, the membrane electrode assembly 300 must be selectively formed, and the electrodes brought into contact with the inner tubular support 110, the intermediate tubular support 130, the outer tubular support 120 and the connection support 200 must be identical electrodes.

In this embodiment, the membrane electrode assembly 300 formed on the outer side of the outer tubular support 120 is referred to as an outer membrane electrode assembly 350, and the membrane electrode assembly 300 formed between the outer side of the inner tubular support 110, the inner side of the intermediate tubular support 130 and both sides of the first connection support 210 is referred to as an inner membrane electrode assembly 340. Further, as in the first embodiment, in this embodiment, two types of membrane electrode assemblies can be formed by changing the arrangement of the anodes and the cathodes.

First, as shown in FIG. 7, in the inner membrane electrode assembly 340, an anode 341, an electrolyte membrane 343 and a cathode 345 are sequentially layered from the outer side of the inner tubular support 110, the inner side of the intermediate tubular support 130 and both sides of the first connection support 210, and, in the outer membrane electrode assembly 350, an anode 351, an electrolyte membrane 353 and a cathode 355 are sequentially layered from the outer side of the outer tubular support 120. In this case, since the electrodes brought into contact with the inner tubular support 110, the intermediate tubular support 130, the outer tubular support 120 and the first connection support 210 are anodes 341 and 351, a short circuit does not occur. Further, since the outermost layer of the inner membrane electrode assembly 340 and the outermost layer of the outer membrane electrode assembly 350 are the cathodes 345 and 355, oxygen is supplied to the space between the inner tubular support 110 and the intermediate tubular support 130 and to the outside of the outer tubular support 120. In contrast, fuel is supplied to the space between the intermediate tubular support 130 and the outer tubular support 120 and to the inside of the inner tubular support 110, and is then transferred to the anodes 341 and 351 through the inner tubular support 110, the intermediate support 130, the outer tubular support 120 and the connection support 200.

Second, as shown in FIG. 8, in the inner membrane electrode assembly 340, a cathode 345, an electrolyte membrane 343 and an anode 341 are sequentially layered from the outer side of the inner tubular support 110, the inner side of the intermediate tubular support 130 and both sides of the first connection support 210, and, in the outer membrane electrode assembly 350, a cathode 355, an electrolyte membrane 353 and an anode 351 are sequentially layered from the outer side of the outer tubular support 120. In this case, since the electrodes brought into contact with the inner tubular support 110, the intermediate tubular support 130, the outer tubular support 120 and the first connection support 210 are cathodes 345 and 355, a short circuit does not occur. Further, since the outermost layer of the inner membrane electrode assembly 340 and the outermost layer of the outer membrane electrode assembly 350 are the anodes 341 and 351, fuel is supplied to the space between the inner tubular support 110 and the intermediate tubular support 130 and to the outside of the outer tubular support 120. In contrast, oxygen is supplied to the space between the intermediate tubular support 130 and the outer tubular support 120 and to the inside of the inner tubular support 110, and is then transferred to the cathodes 345 and 355 through the inner tubular support 110, the intermediate support 130, the outer tubular support 120 and the connection support 200.

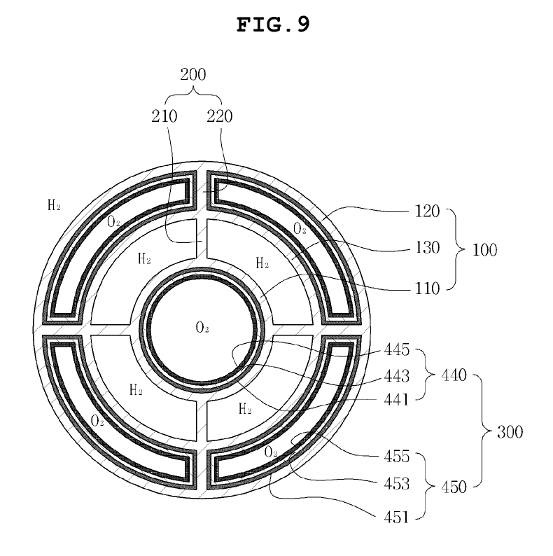

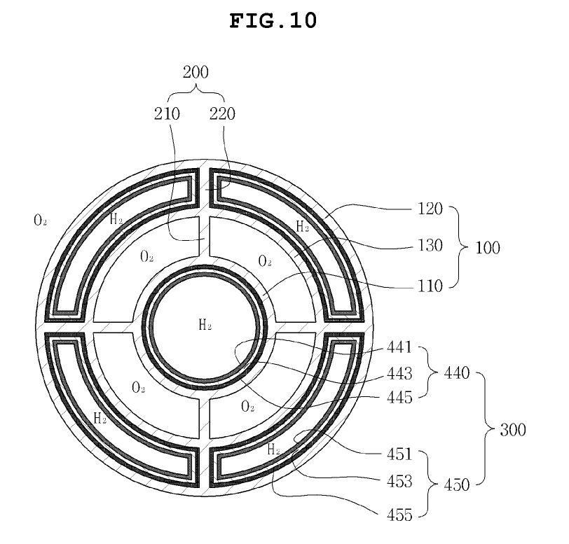

FIGS. 9 and 10 are sectional views showing fuel cells including a multi-tubular support according to a fourth embodiment of the present invention. As shown in FIGS. 9 and 10, each of the fuel cells including a multi-tubular support according to a third embodiment of the present invention includes: a multi-tubular support 100 including an inner tubular support 110, an intermediate tubular support 130 and an outer tubular support 120; a connection support 200 including a first connection support 210 extending from the inner tubular support 110 to the intermediate tubular support 130 and a second connection part 220 extending from the intermediate tubular support 130 to the outer tubular support 120; and a membrane electrode assembly 300 including an inner membrane electrode assembly 440 formed on the inner side of the inner tubular support 110 and an outer membrane electrode assembly 450 formed between the inner side of the outer tubular support 120, the outer side of the intermediate tubular support 130 and both sides of the second connection support 220.

Even in this embodiment, as described above, in order to suitably supply fuel or oxygen and to prevent a short circuit, the membrane electrode assembly 300 must be selectively formed, and the electrodes brought into contact with the inner tubular support 110, the intermediate tubular support 130, the outer tubular support 120 and the connection support 200 must be identical electrodes.

In this embodiment, the membrane electrode assembly 300 formed on the inner side of the inner tubular support 110 is referred to as an inner membrane electrode assembly 440, and the membrane electrode assembly 300 formed between the outer side of the intermediate tubular support 130, the inner side of the outer tubular support 120 and both sides of the second connection support 220 is referred to as an outer membrane electrode assembly 450. Further, as in the first embodiment, in this embodiment, two types of membrane electrode assemblies can be formed by changing the arrangement of the anodes and the cathodes.

First, as shown in FIG. 9, in the inner membrane electrode assembly 440, an anode 441, an electrolyte membrane 443 and a cathode 445 are sequentially layered from the inner side of the inner tubular support 110, and, in the outer membrane electrode assembly 450, an anode 451, an electrolyte membrane 453 and a cathode 455 are sequentially layered from the outer side of the intermediate tubular support 130, the inner side of the outer tubular support 120 and both sides of the second connection support 220. In this case, since the electrodes brought into contact with the inner tubular support 110, the intermediate tubular support 130, the outer tubular support 120 and the second connection support 220 are anodes 441 and 451, a short circuit does not occur. Further, since the outermost layer of the inner membrane electrode assembly 440 and the outermost layer of the outer membrane electrode assembly 450 are the cathodes 445 and 455, oxygen is supplied to the space between the intermediate tubular support 130 and the outer tubular support 120 and to the inside of the inner tubular support 110. In contrast, fuel is supplied to the space between the inner tubular support 110 and the intermediate tubular support 130 and to the outside of the outer tubular support 120, and is then transferred to the anodes 441 and 451 through the inner tubular support 110, the intermediate support 130, the outer tubular support 120 and the connection support 200.

Second, as shown in FIG. 10, in the inner membrane electrode assembly 440, a cathode 445, an electrolyte membrane 443 and an anode 441 are sequentially layered from the inner side of the inner tubular support 110, and, in the outer membrane electrode assembly 450, a cathode 445, an electrolyte membrane 443 and an anode 441 are sequentially layered from the outer side of the intermediate tubular support 130, the inner side of the outer tubular support 120 and both sides of the second connection support 220. In this case, since the electrodes brought into contact with the inner tubular support 110, the intermediate tubular support 130, the outer tubular support 120 and the second connection support 220 are cathodes 445 and 455, a short circuit does not occur. Further, since the outermost layer of the inner membrane electrode assembly 440 and the outermost layer of the outer membrane electrode assembly 450 are the anodes 441 and 451, fuel is supplied to the space between the intermediate tubular support 130 and the outer tubular support 120 and to the inside of the inner tubular support 110. In contrast, oxygen is supplied to the space between the inner tubular support 110 and the intermediate tubular support 130 and to the outside of the outer tubular support 120, and is then transferred to the cathodes 445 and 455 through the inner tubular support 110, the intermediate support 130, the outer tubular support 120 and the connection support 200.

As described above, according to the present invention, since a multi-tubular support is employed in a fuel cell, the fuel cell has a stable structure compared to conventional fuel cells, thus improving durability and reliability.

Further, according to the present invention, since the multi-tubular support can be more thinly formed, its electrical resistance is decreased, so electrical collection is advantageously conducted, thereby increasing the diffusion capacity of reaction gases.

Further, according to the present invention, since tubular supports are formed into a multi-tubular support, the reaction area is enlarged, so that the efficiency of a fuel cell is increased, thereby decreasing power generation costs. Further, since power density per volume is increased, the volume of the entire fuel cell system can be decreased.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

Simple modifications, additions and substitutions of the present invention belong to the scope of the present invention, and the specific scope of the present invention will be clearly defined by the appended claims.

What is claimed is:

1. A fuel cell including a multi-tubular support, comprising:
a multi-tubular support composed of a plurality of tubular supports which are concentrically arranged and have different diameters;
at least one connection support extending from an innermost tubular support to an outermost tubular support of the plurality of tubular supports; and
a membrane electrode assembly formed on the multi-tubular support or the connection support.

2. The fuel cell according to claim 1, wherein the multi-tubular support includes an inner tubular support and an outer tubular support,
the connection support extends from the inner tubular support to the outer tubular support, and
the membrane electrode assembly includes an inner membrane electrode assembly formed on an inner side of the inner tubular support and an outer membrane electrode assembly formed on an outer side of the outer tubular support.

3. The fuel cell according to claim 2, wherein the inner membrane electrode assembly includes an anode, an electrolyte membrane and a cathode sequentially layered in this order on the inner side of the inner tubular support, and the outer membrane electrode assembly includes an anode, an electrolyte membrane and a cathode sequentially layered in this order on the outer side of the outer tubular support.

4. The fuel cell according to claim 2, wherein the inner membrane electrode assembly includes a cathode, an electrolyte membrane and an anode sequentially layered in this order on the inner side of the inner tubular support, and the outer membrane electrode assembly includes a cathode, an electrolyte membrane and an anode sequentially layered in this order on the outer side of the outer tubular support.

5. The fuel cell according to claim 1, wherein the multi-tubular support includes an inner tubular support and an outer tubular support,
the connection support extends from the inner tubular support to the outer tubular support, and
the membrane electrode assembly is formed between an outer side of the inner tubular support, an inner side of the outer tubular support and both sides of the connection support.

6. The fuel cell according to claim 5, wherein the membrane electrode assembly includes an anode, an electrolyte membrane and a cathode sequentially layered in this order on the outer side of the inner tubular support, the inner side of the outer tubular support and both sides of the connection support.

7. The fuel cell according to claim 5, wherein the membrane electrode assembly includes a cathode, an electrolyte membrane and an anode sequentially layered in this order on the outer side of the inner tubular support, the inner side of the outer tubular support and both sides of the connection support.

8. The fuel cell according to claim 1, wherein the multi-tubular support includes an inner tubular support, an intermediate tubular support and an outer tubular support,
the connection support includes a first connection support extending from the inner tubular support to the intermediate tubular support and a second connection part extending from the intermediate tubular support to the outer tubular support, and
the membrane electrode assembly includes an inner membrane electrode assembly formed between an outer side of the inner tubular support, an inner side of the intermediate tubular support and both sides of the first connection support and an outer membrane electrode assembly formed on an outer side of the outer tubular support.

9. The fuel cell according to claim 8, wherein the inner membrane electrode assembly includes an anode, an electrolyte membrane and a cathode sequentially layered in this order on the outer side of the inner tubular support, the inner side of the intermediate tubular support and both sides of the first connection support, and the outer membrane electrode assembly includes an anode, an electrolyte membrane and a cathode sequentially layered in this order on the outer side of the outer tubular support.

10. The fuel cell according to claim 8, wherein the inner membrane electrode assembly includes a cathode, an electrolyte membrane and an anode sequentially layered in this order on the outer side of the inner tubular support, the inner side of the intermediate tubular support and both sides of the first connection support, and the outer membrane electrode assembly includes a cathode, an electrolyte membrane and an anode sequentially layered in this order on the outer side of the outer tubular support.

11. The fuel cell according to claim 1, wherein the multi-tubular support includes an inner tubular support, an intermediate tubular support and an outer tubular support,
the connection support includes a first connection support extending from the inner tubular support to the intermediate tubular support and a second connection part extending from the intermediate tubular support to the outer tubular support, and
the membrane electrode assembly includes an inner membrane electrode assembly formed on an inner side of the inner tubular support and an outer membrane electrode assembly formed between an inner side of the outer tubular support, an outer side of the intermediate tubular support and both sides of the second connection support.

12. The fuel cell according to claim 11, wherein the inner membrane electrode assembly includes an anode, an electrolyte membrane and a cathode are sequentially layered in this order on the inner side of the inner tubular support, and the outer membrane electrode assembly includes an anode, an electrolyte membrane and a cathode sequentially layered in this order on the outer side of the intermediate tubular support, the inner side of the outer tubular support and both sides of the second connection support.

13. The fuel cell according to claim 11, wherein the inner membrane electrode assembly includes a cathode, an electrolyte membrane and an anode sequentially layered in this order on the inner side of the inner tubular support, and the outer membrane electrode assembly includes a cathode, an electrolyte membrane and an anode sequentially layered in this order on the outer side of the intermediate tubular support, the inner side of the outer tubular support and both sides of the second connection support.

14. The fuel cell according to claim 1, wherein the multi-tubular support is integrated with the connection support.

15. The fuel cell according to claim 1, wherein the number of the connection support is two or more.

16. The fuel cell according to claim 1, wherein the multi-tubular support or the connection support is made of ceramic.

17. The fuel cell according to claim 1, wherein the multi-tubular support or the connection support is made of a metal.

18. The fuel cell according to claim 17, wherein the metal is selected from the group consisting of iron, copper, aluminum, nickel, chromium, alloys thereof, and combinations thereof.

19. The fuel cell according to claim 1, wherein the multi-tubular support or the connection support is made of a porous material.
